(19) United States
(12) Patent Application Publication
(10) Pub. No.: US 2024/0426631 A1
(43) Pub. Date: Dec. 26, 2024

(54) DATA GENERATION DEVICE AND DATA STORAGE DEVICE

(71) Applicant: DENSO CORPORATION, Kariya-city (JP)

(72) Inventors: Taiki SUZUKI, Kariya-city (JP); Satoshi HORIHATA, Kariya-city (JP)

(21) Appl. No.: 18/823,299

(22) Filed: Sep. 3, 2024

Related U.S. Application Data
(63) Continuation of application No. PCT/JP2023/002442, filed on Jan. 26, 2023.

(30) Foreign Application Priority Data
Mar. 4, 2022 (JP) 2022-033550

(51) Int. Cl. G01C 21/00; G06V 20/58

(52) U.S. Cl. CPC G01C 21/3807; G01C 21/3841; G06V 20/584

(57) ABSTRACT

A data generation device includes a data generation unit configured to generate data. The data generation unit is further configured to generate, as the data, traffic light identification data including lane information for identifying a lane in which a vehicle is traveling, traffic light information for identifying a plurality of traffic lights installed at an intersection to which the lane is connected, and confidence information indicating a degree of confidence set for each of the plurality of traffic lights. The traffic light identification data has a data structure that allows the traffic light that should be trusted to be identified based on the degrees of confidence set for the plurality of traffic lights depending on the lane in which the vehicle is traveling.

### CROSS-REFERENCE TO RELATED APPLICATION

This application is a continuation application of International Application No. PCT/JP2023/002442 filed Jan. 26, 2023 which designated the U.S. and claims priority to Japanese Patent Application No. 2022-033550 filed Mar. 4, 2022, the contents of each of which are incorporated herein by reference.

### BACKGROUND

### Technical Field

This disclosure relates to a data generation device and a data storage device.

### Related Art

For example, in the field of autonomous driving of vehicles, when there are a plurality of traffic lights at an intersection, a vehicle may not be able to determine the indication of which traffic light to obey, based on camera-captured images alone. Therefore, techniques are known that propose generating map data that associates a lane in which the vehicle is traveling with the traffic light installed at the intersection to which the lane is connected.

### BRIEF DESCRIPTION OF THE DRAWINGS

In the accompanying drawings:

FIG. 1 is a functional block diagram of an example configuration of a map generation system according to one embodiment;

FIG. 2 is an illustration of an example configuration of a traffic light association data table;

FIG. 3 is a flowchart of an example method for generating the traffic light association data table;

FIG. 4 is a visual illustration of an example situation where a travel trajectory and a traffic light are provisionally associated with each other;

FIG. 5 is a visual illustration of an example of different situations where a travel trajectory and traffic lights are provisionally associated with each other;

FIG. 6 is a flowchart of an example of a provisional association process;

FIGS. 7A-7B are visual illustrations of an example of a stop information assignment process;

FIGS. 8A-8C are illustrations of an example of advantages of the stop information assignment process;

FIG. 9 is an illustration (part 1) of an example method for determining a travel direction through a travel direction information assignment process;

FIGS. 10A-10B are illustrations (part 2) of an example method for determining a travel direction through the travel direction information assignment process;

FIG. 11 is an illustration of an example method for determining presence or absence of traffic congestion through a traffic congestion determination information assignment process;

FIG. 12 is a visual illustration (part 1) of an example method for classifying each recognized traffic light into an own signal or a non-own signal;

FIG. 13 is a visual illustration (part 2) of an example method for classifying each recognized traffic light into an own signal or a non-own signal;

FIG. 14 is a visual illustration (part 3) of an example method for classifying each recognized traffic light into an own signal or a non-own signal;

FIG. 15 is a visual illustration (part 4) of an example method for classifying each recognized traffic light into an own signal or a non-own signal;

FIG. 16 is a visual illustration (part 5) of an example method for classifying each recognized traffic light into an own signal or a non-own signal;

FIG. 17 is a visual illustration of an example of an integration process;

FIG. 18 is a schematic illustration of an example configuration of an integration table;

FIG. 19 is a schematic illustration of an example configuration of a traffic light extraction table;

FIG. 20 is a schematic diagram of an example configuration of a confidence table;

FIG. 21 is a schematic diagram of an example configuration of a reinforced confidence table;

FIG. 22 is a schematic diagram of an example configuration of an extracted data table; and

FIG. 23 is a schematic diagram of an example of one record of the traffic light association data table.

### DESCRIPTION OF SPECIFIC EMBODIMENTS

Although the known techniques, as disclosed in JP 2018-005629 A and JP 2019-191318 A, associate the lanes with the traffic lights, the accuracy of association is not guaranteed. That is, an incorrect traffic light may be erroneously associated with the lane in which the vehicle is traveling. Therefore, there is room for further improvement to implement safer autonomous driving of vehicles.

In view of the above, it is desired to have a data generation device for, even in cases where there are a plurality of traffic lights at an intersection connected to a lane in which a vehicle is traveling, generating traffic light identification data that enables identification of a traffic light to be trusted among a plurality of traffic lights, and a data storage device for storing the traffic light identification data.

According to one aspect of the present disclosure, a data generation device includes a data generation unit configured to generate data. The data generation unit is further configured to generate, as the data, traffic light identification data including lane information for identifying a lane in which a vehicle is traveling, traffic light information for identifying a plurality of traffic lights installed at an intersection to which the lane is connected, and confidence information indicating a degree of confidence set for each of the plurality of traffic lights. The traffic light identification data has a data structure that allows the traffic light that should be trusted to be identified based on the degrees of confidence set for the plurality of traffic lights depending on the lane in which the vehicle is traveling.

According to one aspect of the present disclosure, a data storage device includes a data storage unit configured to store data. The data storage unit is further configured to store, as the data, traffic light identification data including lane information for identifying a lane in which a vehicle is traveling, traffic light information for identifying a plurality of traffic lights installed at an intersection to which the lane is connected, and confidence information indicating a degree of confidence set for each of the plurality of traffic lights. The traffic light identification data has a data structure that allows the traffic light that should be trusted to be identified based on the degrees of confidence set for the plurality of traffic lights depending on the lane in which the vehicle is traveling.

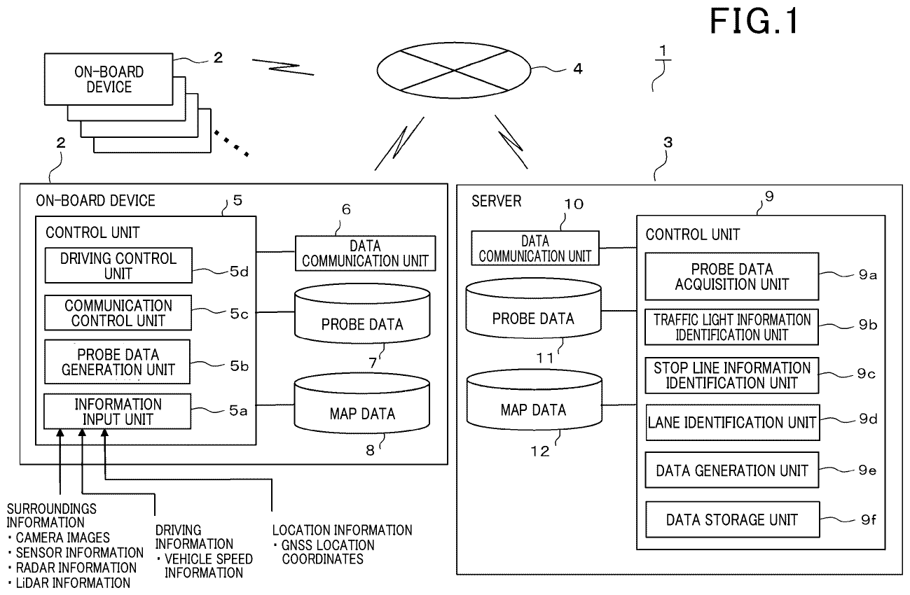

Hereinafter, a data generation device and a data storage device according to one embodiment of the present disclosure will now be described with reference to the accompanying drawings. A map generation system 1 illustrated in FIG. 1 is configured such that an on-board device 2 mounted to each of a plurality of vehicles and a server 3 disposed on the network side can communicate data via a communication network 4, such as the internet. The vehicle carrying the on-board device 2 may be a vehicle with or without an autonomous driving function. The on-board devices 2 and the server 3 are in a many-to-one relationship, and the server 3 is capable of data communication with a plurality of on-board devices 2. The server 3 is an example of the data generation device and data storage device. It should be noted that the present disclosure may be applied to a situation where there is only one vehicle carrying the on-board device 2 and the sever 3.

Each on-board device 2 includes a control unit 5, a data communication unit 6, a probe data storage unit 7, and a map data storage unit 8. The control unit 5 is mainly configured as a microcomputer including a central processing unit (CPU), a read-only memory (ROM), a random-access memory (RAM), and an input/output (I/O) interface. The microcomputer executes computer programs stored in a non-transitory tangible storage medium, thereby performing processes corresponding to the computer programs and controlling the overall operation of the on-board device 2.

The control unit 5 includes an information input unit 5a, a probe data generation unit 5b, a communication control unit 5c, and a driving control unit 5d. The information input unit 5a receives surroundings information about surroundings of the vehicle, driving information about driving of the vehicle, and location information about the location of the vehicle. The information input unit 5a receives, as the surroundings information, camera images in the direction in which the vehicle is traveling, captured by an on-board camera, sensor information detected around the vehicle by sensors, such as a millimeter wave sensor and the like, radar information detected around the vehicle by a radar, and LiDAR information detected around the vehicle by a Light

Detection and Ranging (LiDAR). The camera images include traffic lights, traffic signs, billboards, stop lines painted on the road surfaces, lane demarcation lines, crosswalks, etc.

The information input unit 5a receives, as the driving information, vehicle speed information detected by a vehicle speed sensor. The information input unit 5a receives, as the location information, positioning signals, i.e., navigation signals transmitted from positioning satellites constituting the Global Navigation Satellite System (GNSS). The information input unit 5a is a device that successively detects the current location of the information input unit 5a, and thus the current location of the vehicle equipped with the on-board device 2, by receiving navigation signals from the GNSS positioning satellites. For example, the GNSS outputs positioning results every 100 milliseconds when successfully receiving positioning signals from four or more positioning satellites. The location information may also be acquired from the Global Positioning System (GPS), GLONASS, Galileo, IRNSS, QZSS, Beidou, etc.

When the surroundings information, the driving information and the location information are input to the information input unit 5a, the probe data generation unit 5b generates probe data from these various items of input information and stores the generated probe data in the probe data storage unit 7. The probe data is data including the surroundings information, the driving information, and the location information, and indicating locations, colors, characteristics, and relative positional relationships of traffic lights on roads, traffic signs, billboards, stop lines painted on road surfaces, lane demarcation lines, crosswalks, and the like. The probe data also includes data indicating various items of information about a road shape, road features, a road width and the like of the road on which the vehicle is traveling.

The communication control unit 5c reads the probe data stored in the probe data storage unit 7, for example, when a predetermined time has elapsed or the distance traveled by the vehicle has reached a predetermined distance, and causes the data communication unit 6 to transmit the probe data thus read to the server 3. Instead of using the elapsed time or the distance traveled by the vehicle as a trigger as described above, in a configuration where the server 3 transmits a probe data transmission request to the on-board device 2 every predefined cycle, the communication control unit 5c reads the probe data stored in the probe data storage unit 7 and transmits the read probe data from the data communication unit 6 to the server 3 when the data communication unit 6 receives the probe data transmission request transmitted from the server 3. When transmitting the probe data from the data communication unit 6 to the server 3, the communication control unit 5c may transmit the probe data from the data communication unit 6 to the server 3 in segment units that are predetermined area units for managing maps or in area units unrelated to the segment units.

When the map data transmitted from the server 3 is received by the data communication unit 6, the driving control unit 5d stores the received map data in the map data storage unit 8, reads from the map data storage unit 8 the map data including necessary information according to the location information of the vehicle carrying the on-board device (that may hereinafter be referred to as a subject vehicle), and then performs driving control of the subject vehicle according to the map data read from the map data storage unit 8. The driving control unit 5d may previously store wide-area map data in the map data storage unit 8, read from the wide-area map data local-area map data according to the location of the subject vehicle, and control driving of the subject vehicle. As an alternative, the driving control unit 5d may transmit a map data transmission request according to the location of the subject vehicle from the data communication unit 6 to the server 3 and acquire the local-area map data from the server 3.

The server 3 includes a control unit 9, a data communication unit 10, a probe data storage unit 11, and a map data storage unit 12. The control unit 9 is mainly configured as a microcomputer including a CPU, a ROM, a RAM, and an input/output (I/O) interface. The microcomputer executes computer programs stored in a non-transitory tangible storage medium, thereby performing processes corresponding to the computer programs and controlling the overall operation of the server 3. The computer program to be executed by the microcomputer includes a map generation program and the like.

The control unit 9 includes a probe data acquisition unit 9a, a traffic light identification unit 9b, a stop line information identification unit 9c, a lane identification unit 9d, a traffic light association data table generation unit 9e, and a traffic light association data table storage unit 9f. Hereinafter, the traffic light association data table generation unit 9e may be referred to simply as a data generation unit 9e, and the traffic light association data table storage unit 9f may be referred to simply as a data storage unit 9f.

When the probe data transmitted from the on-board device 2 is received by the data communication unit 10, the probe data acquisition unit 9a stores the received probe data in the probe data storage unit 11 and reads necessary information probe data from the probe data storage unit 11 to acquire the probe data. The probe data acquisition unit 9a acquires probe data from a plurality of vehicles by the data communication unit 10 receiving probe data transmitted from each of the on-board devices 2 mounted to the plurality of vehicles.

The traffic light information identification unit 9b identifies traffic light information about a plurality of traffic lights at an intersection based on the probe data acquired by the probe data acquisition unit 9a. The traffic light information is information that is managed by associating a single traffic light or each of a plurality of traffic lights at an intersection that the lane in which the vehicle is traveling is connected with a traffic light ID allowing identification of each of the traffic lights at the intersection. The traffic light information is information allowing identification of at least the traffic light location, traffic light size, traffic light direction, traffic light colors, traffic light type, and arrow direction information of each traffic light.

The traffic light location may be represented by three-dimensional coordinates indicating the center of the traffic light. The traffic light size may be represented by the coordinates of the location of the center of the traffic light, the coordinates of locations of end points, the horizontal dimension in the width direction, the vertical dimension in the height direction, and so on. The traffic light direction is represented by a normal vector perpendicular to the direction in which the lamps are aligned, which is the normal vector direction of the traffic light. The traffic light colors may include blue or green to indicate permission to enter the intersection area, yellow to indicate permission to enter the intersection area while paying attention to other traffic, and red to prohibit entry into the intersection area, and the like. The traffic light type may be a type based on the shape of the traffic light, such as vertical or horizontal type, or a type based on the number of lamps that the traffic light is equipped with. The arrow direction information is information such as arrow directions of arrow lamps (e.g., left turn direction, right turn direction, straight direction, etc.) if the traffic light is equipped with arrow lamps.

The stop line information identification unit 9c identifies stop line information about each of a plurality of stop lines at an intersection based on the probe data acquired by the probe data acquisition unit 9a. The stop line information is information that is managed by association with stop line IDs allowing identification of stop lines, and may include information allowing identification of the stop line location, stop line size, and stop line type of each stop line.

The stop line location may be represented by three-dimensional coordinates indicating the location of the center of the stop line. The stop line size may be represented by coordinates of the location of the center of the stop line, coordinates of locations of the end points of the stop line, a dimension of the stop line in the road width direction, and a dimension of the stop line in the lane direction (depth direction), and so on. The stop line type may be classified by presence or absence of a crosswalk parallel to the stop line.

The lane identification unit 9d identifies lane information about the lane in which the vehicle is traveling based on the probe data acquired by the probe data acquisition unit 9a. In this case, the lane identification unit 9d identifies the lane centerline of each lane by statistically processing a plurality of data groups indicating a travel trajectory of the vehicle and lane demarcation lines, thereby identifying the lane in which the vehicle is traveling. That is, the lane identification unit 9d may identify the lane centerline of each lane by excluding data outside a predefined range from the plurality of data groups indicating the travel trajectory of the vehicle and lane demarcation lines, and then averaging the data within the predefined range, thereby identifying the lane in which the vehicle is traveling. The lane information thus configured is information that is managed by association with lane IDs allowing identification of the lane in which the vehicle is traveling.

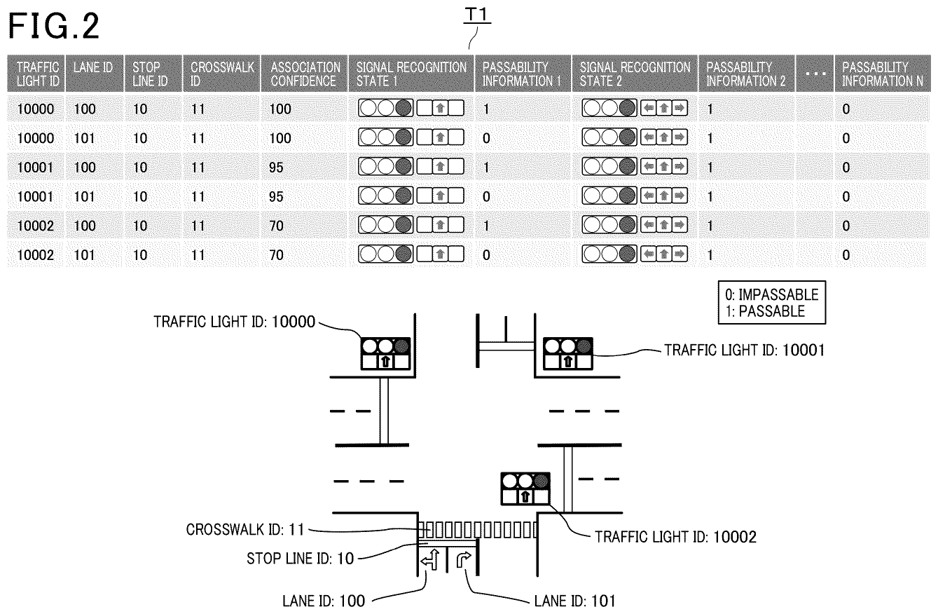

The data generation unit 9e is configured to generate various items of data, and may generate the traffic light association data table T1 as illustrated in FIG. 2. The traffic light association data table T1 is an example of traffic light identification data and includes at least various ID information such as the traffic light information and lane information described above. The traffic light association data table T1 further includes association confidence information, which is an example of confidence information. The confidence information is information that indicates a degree of confidence set for each of the plurality of traffic lights, that is, a degree to which the traffic light can be trusted when controlling autonomous driving of the vehicle.

According to the traffic light association data table T1, a different degree of confidence is set for each of the plurality of traffic lights depending on the lane in which the vehicle is traveling. Therefore, the traffic light association data table T1 implements a data structure provided to allow identification of the traffic light that should be trusted when controlling autonomous driving of the vehicle by comparing the degrees of confidence set for the respective traffic lights.

The data storage unit 9f is configured to store various items of data. For example, the data storage unit 9f may store the traffic light association data table T1 illustrated in FIG. 2 in the map data storage unit 12.

For example, according to the traffic light association data table T1 illustrated in FIG. 2, various items of ID information, such as traffic light information, lane information, and stop line information, are unique information within the map data. Using such a traffic light association data table T1, it is possible to control a vehicle that is about to pass through or stop at an intersection in the following manner.

That is, for example, at an intersection such as the one illustrated in FIG. 2, a case is assumed in which a vehicle traveling in a lane with lane information “100” enters the intersection. In this case, the on-board device 2 identifies a plurality of traffic lights, in this case, three traffic lights with traffic light information “10000”, “10001” and “10002”, as traffic lights associated with the lane with lane information “100” by referring to the traffic light association data table T1. In cases where a plurality of traffic lights are associated with a lane in this manner, the on-board device 2 obeys the traffic light with the highest confidence information among the plurality of traffic lights. According to the traffic light association data table T1 illustrated in FIG. 2, the traffic light with the highest confidence information among the three traffic lights is the traffic light with the traffic light information “10000”. Therefore, the on-board device 2 controls driving of the vehicle according to the traffic light with the traffic light information “10000”.

In addition, the on-board device 2 refers to passability information stored in the traffic light association data table T1. The on-board device 2 recognizes the lighting state of the traffic light whose traffic light information is “10000” using the camera images, and compares the recognized state with signal recognition state information stored in the traffic light association data table T1. The on-board device 2 then refers to the passability information corresponding to the lighting state of the traffic light whose traffic light information is “10000”. The on-board device 2controls the vehicle to pass through the intersection when the referred passability information indicates a numerical value of 1, and controls the vehicle to stop at the stop line before the intersection when the referred passability information indicates a numerical value of 0.

As described above, based on the traffic light association data table T1, it is possible to determine which of the plurality of traffic lights a vehicle should obey when entering or passing through an intersection.

In addition, for example, in cases where the shape of the intersection is complex or the disposition of the traffic lights is complex, even when the traffic light to be trusted is successfully identified from the plurality of traffic lights, a determination may fail to be made as to in which lighting state of the traffic light the vehicle is allowed to enter the intersection or to stop before the intersection. The traffic light association data table T1 further includes signal recognition state information indicating the lighting state of each traffic light and passability information indicating whether to allow the vehicle to pass through the intersection. Therefore, it is possible to determine not only whether to allow the vehicle to enter the intersection or but also whether to allow the vehicle to stop before the intersection, according to the lighting state of the traffic light.

According to the traffic light association data table T1, a plurality of traffic lights are each assigned a different degree of confidence depending on the lane in which the vehicle is traveling. This allows driving of the vehicle to be controlled according to the traffic light with the highest degree of confidence among the plurality of traffic lights recognized by the on-board device 2. Therefore, even in a case of inaccurate association with a proper traffic light to be trusted, safety of autonomous driving of the vehicle can be sufficiently ensured by having the vehicle obey the traffic light with the highest degree of confidence among the plurality of traffic lights actually recognized by the on-board device 2. In this case, even when the traffic light with the highest degree of confidence is identified among the plurality of traffic lights recognized by the on-board device 2, the on-board device 2 may not obey the traffic light with the highest degree of confidence if the highest degree of confidence is lower than a predefined value.

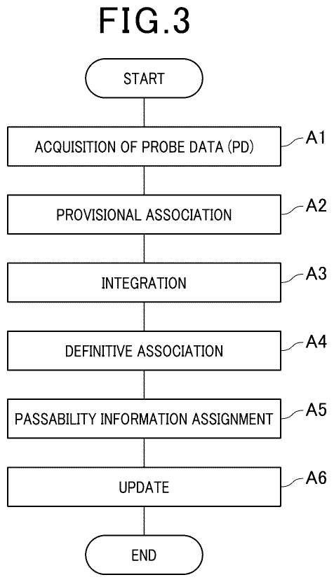

An example of a generation method for generating the traffic light association data table T1 illustrated in FIG. 2 will now be described in detail. In the present embodiment, the traffic light association data table T1 is generated by the server 3. FIG. 3 illustrates a main flow of the generation method. That is, the generation method includes a probe data acquisition process (step A1), a provisional association process (step A2), an integration process (step A3), a definitive association process (step A4), a passability information assignment process (step A5), and a database update process (step A6). Here, the provisional association process (step A2) is an example of a provisional process, and the definitive association process (step A4) is an example of a definitive process.

In the probe data acquisition process (step A1), the server 3 acquires pieces of probe data acquired from the plurality of on-board devices 2. The probe data may hereinafter be referred to simply as PD. The probe data includes at least, for each vehicle carrying the on-board devices 2, location information indicating a location of the vehicle, travel trajectory information indicating a travel trajectory of the vehicle, speed information indicating a speed of the vehicle, yaw rate information indicating a yaw angle or yaw rate of the vehicle, inter-vehicle distance information indicating a distance between the vehicle and a preceding vehicle, location information indicating a location of each traffic light identified by analyzing the camera images, lighting information indicating a lighting state of each traffic light identified by analyzing the camera images, and shape information indicating a shape of each traffic light identified by analyzing the camera images. At this stage of the probe data acquisition process, it is not necessary to accurately identify which lane the vehicle is traveling in or which traffic light is detected from the camera images.

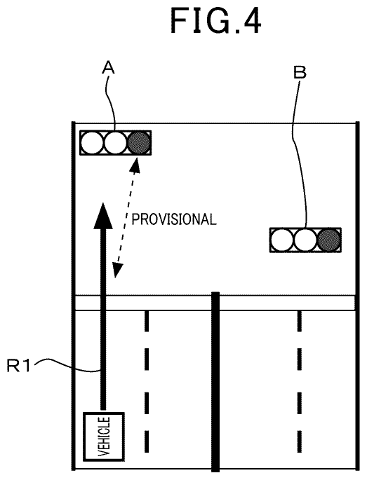

In the provisional association process (step A2), the server 3 performs provisional association in units of probe data acquired in the probe data acquisition process. The “association” in the present disclosure may also be referred to as the mutual correspondence of two or more different items of information, or the so-called pairing of information. In the provisional association process, the server 3 generates information indicating whether travel trajectories and traffic lights included in the acquired probe data are associated with each other. FIG. 4 visually illustrates a state in which the travel trajectory R1 and the traffic light A are provisionally associated with each other. In this case, the travel trajectory R1 is provisionally associated with the traffic light A, but not with the traffic light B.

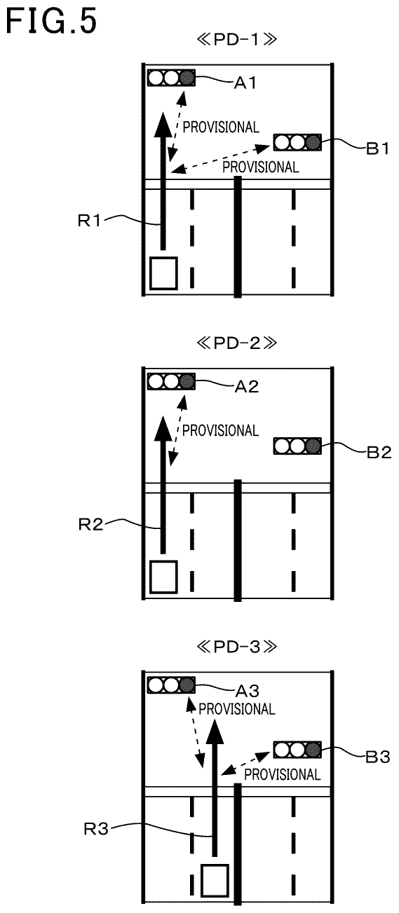

At this stage of the provisional association process, since there may be cases in which the provisional association between the travel trajectories and the traffic lights is incorrect due to the recognized situations of the camera images or influence of the external environment, such cases are also acceptable. That is, as illustrated in FIG. 5, even in cases where the vehicle is traveling in the same lane, the traffic lights that are provisionally associated with the travel trajectory R1 may differ, depending on the recognized situations of the camera images, the influence of the external environment, etc. According to the case PD-1, the travel trajectory R1 is provisionally associated with the traffic light A1 and the traffic light B1. According to the case PD-2, the travel trajectory R2 is provisionally associated only with the traffic light A2, but not with the traffic light B2. According to the case PD-3, the travel trajectory R3 is provisionally associated with the traffic light A3 and the traffic light B3.

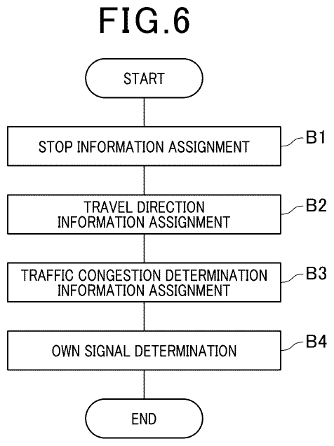

The provisional association process for generating the provisional association information as described above will now be described in detail. As illustrated in FIG. 6, the provisional association process includes a stop information assignment process (step B1), a travel direction information assignment process (step B2), a traffic congestion determination information assignment process (step B3), and a subject signal determination process (step B4).

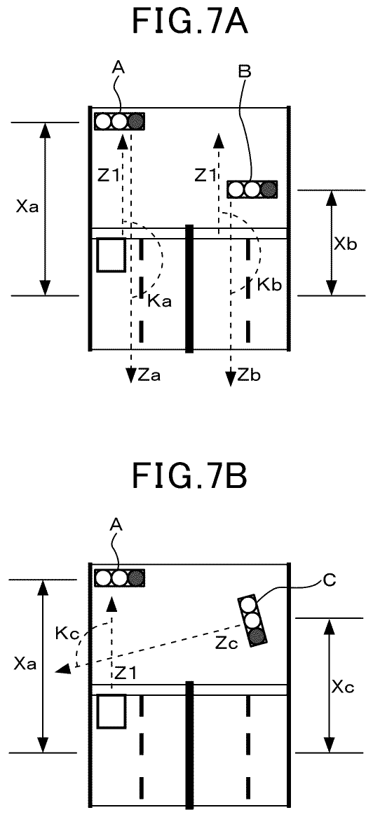

In the stop information assignment process (step B1), as illustrated in FIGS. 7A-7B, the server 3 determines whether there has been a stopping behavior of the vehicle within X meters before the traffic light of interest, based on the speed information of the vehicle or the like. When there has been a stopping behavior of the vehicle within X meters before the traffic light of interest, the server 3 assigns the stop information to the traffic light of interest. The distance X may be changed and set as appropriate, taking into account, for example, the environmental situation around the vehicle. The distance X may be set differently for each traffic light.

In the stop information assignment process, the server 3 assigns stop information only when the angle between the travel direction of the vehicle and the direction of the normal vector of the traffic light is greater than or equal to a predefined angle, in order to exclude traffic lights at the right or left turn destination. The predefined angle may be changed and set as appropriate. According to the example in FIGS. 7A-7B, the predefined angle is set, for example, within a predefined angular range of 150 degrees to 180 degrees.

That is, according to FIG. 7A, there has been a stopping behavior of the vehicle within Xa meters before the traffic light of interest A, and the angle Ka between the travel direction Z1 of the vehicle and the direction Za of the normal vector of the traffic light A is 180 degrees, that is, within the predefined angular range. In addition, there has been a stopping behavior of the vehicle within Xb meters before the traffic light of interest B, and the angle Kb between the travel direction Z1 of the vehicle and the direction Zb of the normal vector of the traffic light B is 180 degrees, that is, within the predefined angular range. Therefore, the server 3 assigns, to each of the traffic light A and the traffic light B, information indicating that there has been a stopping behavior of the vehicle before the traffic light, that is, the stop information. That is, the server 3 associates the traffic light A and the traffic light B with the stop information.

According to FIG. 7B, although there has been a stopping behavior of the vehicle within Xc meters before the traffic light of interest C, the angle Kc between the travel direction Z1 of the vehicle and the direction Zc of the normal vector of the traffic light C is outside the predefined angular range. Therefore, the server 3 does not assign, to the traffic light C, information indicating that the vehicle has stopped before the traffic light, that is, the stop information. That is, the server 3 does not associate the traffic signal C with the stop information.

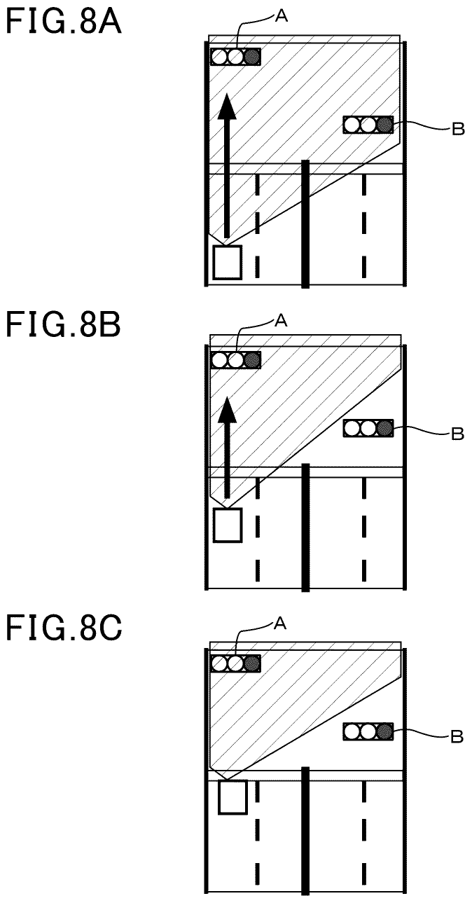

Such a process provides the following advantages. As illustrated in FIG. 8, in the actual driving environment of the vehicle, there is a possibility that the traffic light B may not be visible, i.e., out of the camera's field of view, depending on the location of the vehicle. In addition, the camera may fail to recognize the traffic light B due to an obstacle such as a large vehicle traveling alongside the subject vehicle.

In more detail, FIG. 8A illustrates an example situation in which there has not been a stopping behaviour at the stage before the vehicle entering the intersection. In this state, the vehicle can recognize the lighting state of the traffic light B, in this case, the red lighting state, using the camera. However, at this stage, there has not been yet a stopping behaviour. Therefore, even if the camera has successfully recognized the red lighting state of the traffic light B, the stop information will not be assigned.

On the other hand, FIGS. 8B and 8C illustrate an example situation where there has been a stopping behavior of the vehicle before each traffic light of interest. In this state, the camera may fail to recognize the traffic light B due to the camera's field of view or the like. Therefore, even though there has been a stopping behavior of the vehicle before the traffic light B and the traffic signal B is in a red lighting state, the camera fails to recognize the traffic light B. Thus, the traffic signal B will not be assigned the stop information.

In contrast, according to the stop information assignment process described above, it is determined whether there has been a stopping behavior of the vehicle within X meters before each traffic light of interest. That is, rather than determining, just at the time the image of the traffic light was captured by the camera, whether there was a stopping behavior of the vehicle, it is determined whether there has been a stopping behavior of the vehicle within a predefined distance before each traffic light of interest. Therefore, even when there is a stopping behaviour of the vehicle in a situation where the traffic light of interest is not recognized by the camera, it is still possible to assign the stop information to the traffic light of interest. This can improve the coverage rate of the stop information assignment process when assigning stop information, which is one of the elements for association. That is, the situation where the stop information fails to be assigned to the traffic light that should be assigned the stop information can be avoided.

In the travel direction information assignment process (step B2), the server 3 assigns travel direction information indicating the travel direction of the vehicle at the intersection where the traffic lights have been recognized. The travel direction of the vehicle may be determined based on rotation angle information of the vehicle calculated using yaw rate information of the vehicle, based on information about road surface paintings painted on the lane in which the vehicle is traveling, or based on the condition of terrestrial objects such as lane demarcation lines, or based on a combination of these pieces of information as appropriate. The probe data may also include, for example, right-turn information indicating that the vehicle has turned right, left-turn information indicating that the vehicle has turned left, blinker information indicating the operational state of the vehicle's blinkers, etc., and the travel direction of the vehicle may be determined based on such information.

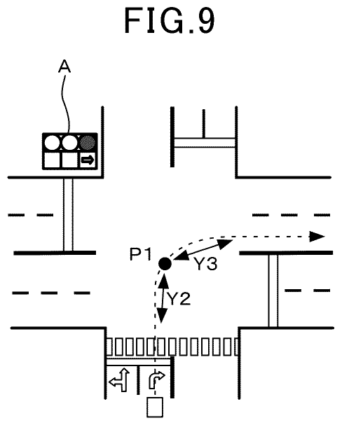

For example, when determining the travel direction of the vehicle based on the yaw rate information, as illustrated in FIG. 9, the server 3 may calculate rotation angles Y2 and Y3 of the vehicle based on the yaw rate information within a predefined longitudinal range centered at the recognition point Pl where the vehicle has recognized traffic light A, and identify the travel direction of the vehicle based on the calculated angle information Y2 and Y3.

When determining the travel direction of the vehicle based on road surface painting information, the server 3 may determine that the travel direction of the vehicle is a right turn direction when the road surface painting information indicates a right turn, a left turn direction when the road surface painting information indicates a left turn, or a straight-ahead direction when the road surface painting information indicates straight-ahead driving.

In the situation illustrated in FIG. 9, the road surface painting on the lane in which the vehicle is traveling is a road surface painting indicating a right turn. Therefore, the server 3 may determine that the travel direction of the vehicle is a right turn direction.

Such a process provides the following advantages. That is, among the traffic lights, there are many traffic lights that are always in the red lighting state and are controlled only by arrow signal lamps. For such traffic lights, the accuracy of association can be improved based on the recognized situation of the arrow signal lamps by the camera and the travel direction of the vehicle.

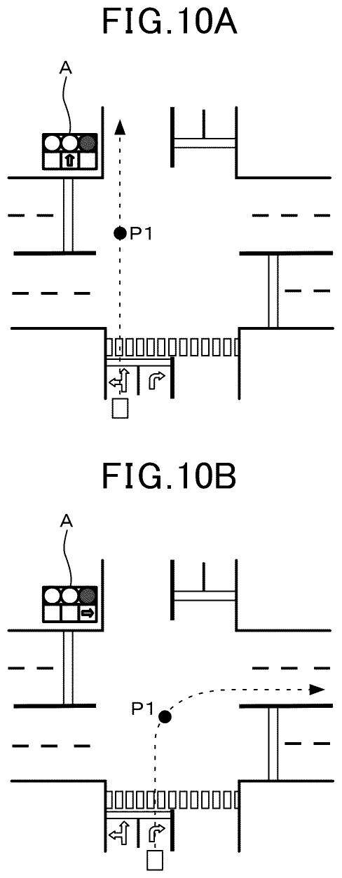

For example, in the state illustrated in FIG. 10A, the traffic signal A is in the red light state and also in the arrow lighting state, which allows the vehicle to go straight ahead. Then, if the vehicle is determined to be moving straight ahead based on the travel direction information of the vehicle, the traffic light A may be recognized as a reliable traffic light because the vehicle is obeying the arrow signal lamp even though the traffic light A is in the red lighting state.

In the state illustrated in FIG. 10B, the traffic signal A is in the red lighting state and also in the arrow lighting state, which allows the vehicle to make a right turn. Then, if the vehicle is determined to be turning right based on the travel direction information of the vehicle, the traffic light A may be recognized as a reliable traffic light because the vehicle is obeying the arrow signal lamp even though the traffic light A is in the red lighting state.

Therefore, taking into account the travel direction of the vehicle at the intersection as well can prevent the traffic light that should be trusted from being unrecognized and overlooked.

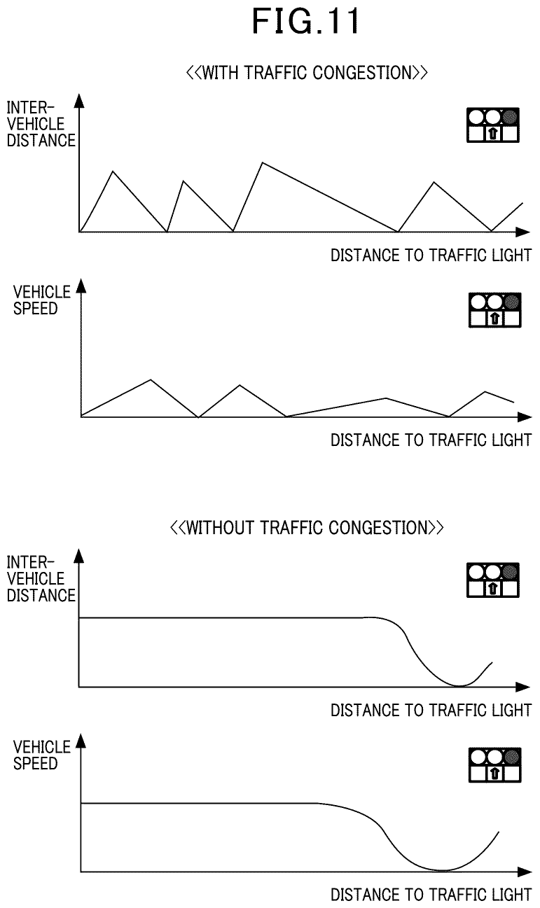

In the traffic congestion determination information assignment process (step B3), the server 3 assigns traffic congestion information indicating whether traffic congestion has occurred before or after the vehicle passes through the intersection or within the intersection. Whether the traffic congestion has occurred may be determined based on information such as the speed information indicating the vehicle's speed and the inter-vehicle distance information indicating the distance between the vehicle and the preceding vehicle. As illustrated in FIG. 11, during traffic congestion, the speed of the vehicle may repeatedly increase and decrease, and the inter-vehicle distance may repeatedly increase and decrease. Therefore, based on the speed information and inter-vehicle distance information, it is possible to accurately determine presence or absence of the he traffic congestion.

In the event of traffic congestion occurring, there may be cases where the lighting state of the traffic light and the vehicle's behavior do not match, such as a case where the vehicle is stationary despite the traffic light being in the green or blue lighting state. Therefore, in cases where it is possible to determine that traffic congestion has occurred based on the traffic congestion information despite there being a mismatch between the lighting state of the traffic light and the vehicle's behavior, the server 3 can recognize the traffic light of interest as the traffic light that should be trusted.

In this manner, taking into account whether traffic congestion is occurring before or after the intersection, or within the intersection can prevent the traffic light that should be trusted from being unrecognized and overlooked. As will be described later, the server 3 can classify each traffic light as an own traffic light or a non-own traffic light by taking into account the traffic congestion information, and may also set an invalid value for traffic lights when the traffic congestion is occurring.

In the own signal determination process (step B4), in addition to the stop information assigned in the stop information assignment process, the travel direction information assigned in the travel direction information assignment process, and the traffic congestion information assigned in the traffic congestion information assignment process, the server 3 comprehensively takes into account the location information and the shape information of traffic lights included in the acquired probe data to classify each of the recognized traffic signals as an own signal or a non-own signal. The own signal is a traffic light corresponding to the lane in which the subject vehicle is traveling, and may be defined as a traffic light that the subject vehicle should refer to. On the other hand, the non-own signal is a traffic light that does not correspond to the lane in which the subject vehicle is traveling, that is, a traffic light other than the own signal, and may be defined as a traffic light that the subject vehicle does not need to refer to or that the subject vehicle needs to refer to less.

In addition, the server 3 may manage the traffic lights by assigning a value of 1 to each traffic light that is classified as an own signal, and assigning a value of 0 to each traffic light that is classified as a non-own signal. As a result of determination made based on the various items of information, the server 3 may identify as own signals all the traffic lights, each of which the probability of being determined as an own signal is relatively high, and identify as non-own signals all the traffic lights, each of which the probability of being determined as an own signal is relatively low. The server 3 may set predefined valid values for traffic lights that are determined to be own signals and set predefined invalid values for traffic lights that are determined to be non-own signals.

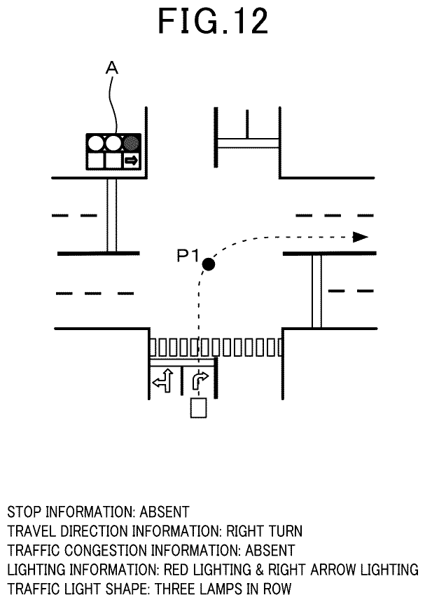

Next, an example of a determination for classifying each recognized traffic light as an own signal or a non-own signal will now be described. FIG. 12 illustrates a situation where a vehicle is making a right turn at an intersection, and there is no stop and no traffic congestion as the vehicle passes through the intersection. When the vehicle passes through the intersection, the traffic signal A is in the red lighting state and in the arrow lighting state, which allows the vehicle to make a right turn. In this situation, the vehicle may be determined to be obeying the behavior of traffic light A. Therefore, the server 3 identifies the traffic light A as an own signal.

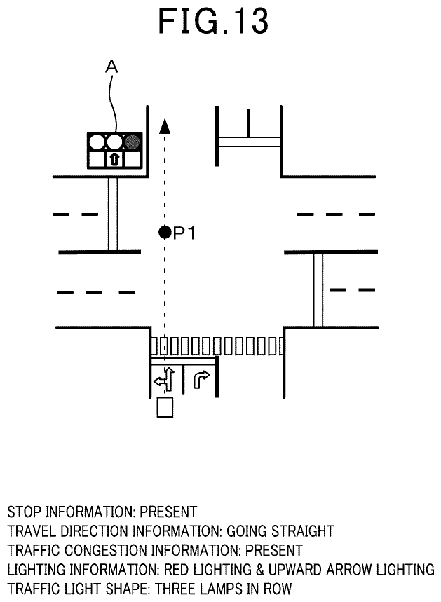

FIG. 13 illustrates a situation where the vehicle is attempting to go straight through the intersection, but there is traffic congestion and the vehicle is stationary before the intersection. In addition, when the vehicle passes through the intersection, the traffic light A is in the red lighting state and also in the arrow lighting state that allows straight movement. In this situation, it may be determined that the vehicle is not obeying the behavior of the traffic light A. However, in this case, there is traffic congestion at the intersection. Therefore, the server 3 sets an invalid value for the traffic light A. That is, the server 3 neither classifies the traffic light A as an own signal nor a non-own signal. In addition, the server 3 does not associate with the traffic light A. Setting an invalid value for the traffic light and not associating it when traffic congestion is occurring can prevent invalid traffic light information from being used, and improves the accuracy of association. In this case, the server 3 may classify the traffic light A as either an own signal or a non-own signal.

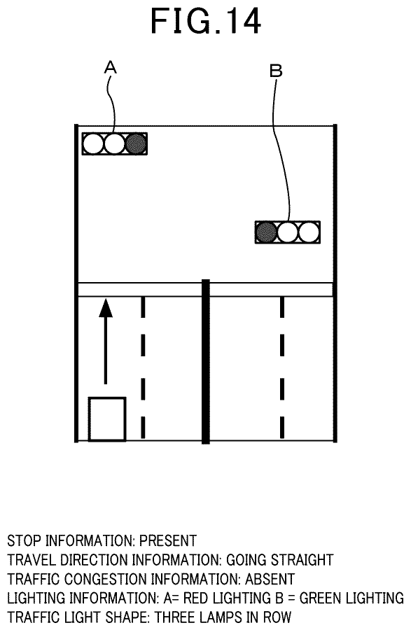

FIG. 14 illustrates a situation where the vehicle is attempting to go straight through the intersection, but is stationary before the intersection. In this case, there is no traffic congestion. The vehicle has recognized the traffic signal A and the traffic signal B. The traffic signal A is in the red lighting state and the traffic signal B is in the green or blue lighting state. In this situation, the vehicle is obeying the behavior of traffic light A, but not that of the traffic light B. Therefore, the server 3 identifies the traffic light A as an own signal and identifies the traffic light B as a non-own signal.

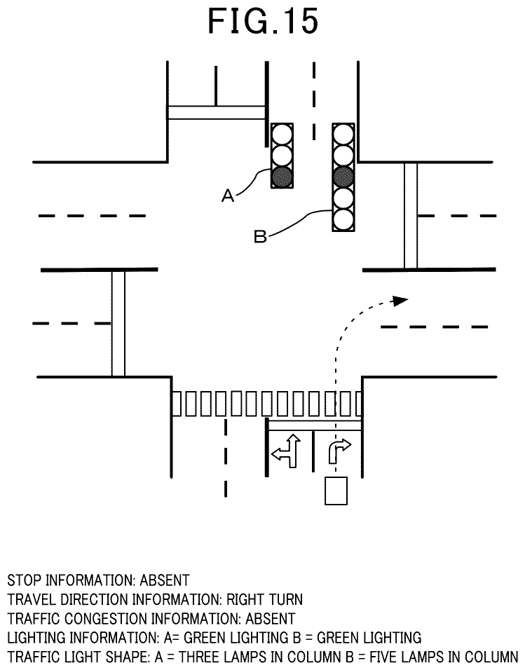

FIG. 15 illustrates a situation at an intersection in a foreign country other than Japan. In this case, the vehicle makes a right turn at the intersection, and there is no stop and no traffic congestion as the vehicle passes through the intersection. The vehicle has recognized the traffic signal A and the traffic signal B, and both the traffic signal A and the traffic signal B are in the green or blue lighting state. In this situation, the vehicle is obeying both the behavior of the traffic light A and the behavior of the traffic light B. Here, the traffic light A is a traffic light with three lights in column and the traffic light B is a traffic light with five lights in column, so the traffic light B may be determined to be a right-turn-only traffic light in, for example, a foreign country other than Japan. Therefore, it may be assumed that the vehicle is obeying the behavior of traffic light B, which is a right-turn-only traffic light. Therefore, the server 3 identifies the traffic light A as a non-own signal and identifies the traffic light B as an own signal.

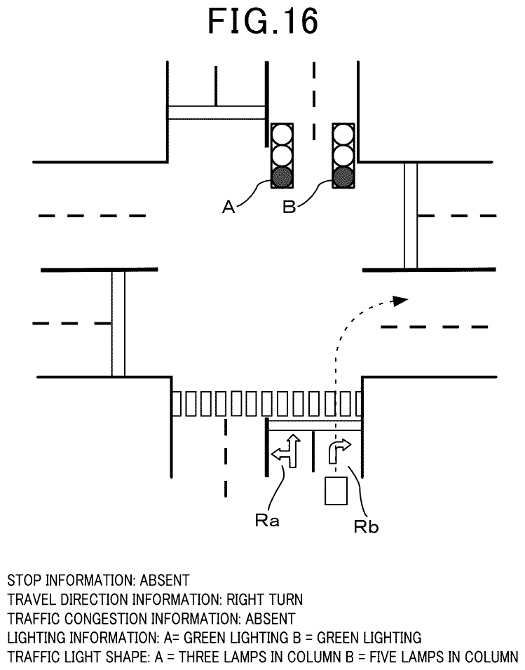

FIG. 16 illustrates an intersection where each lane has a different traffic light that should be referred to. In this case, the vehicle turns right at the intersection, and there is no stop and no traffic congestion as the vehicle passes through the intersection. The vehicle has recognized the traffic signal A and the traffic signal B, and both the traffic signal A and the traffic signal B are in the green lighting state. In this situation, the vehicle is obeying both the behavior of the traffic light A and the behavior of the traffic light B. Here, the traffic light A is a traffic light corresponding to the left lane Ra, and the traffic light B is a traffic light corresponding to the right lane Rb. Therefore, it may be assumed that the vehicle traveling in the right lane Rb is obeying the behavior of the traffic light B, which is the traffic light corresponding to that lane Rb. Therefore, the server 3 identifies the traffic light A as a non-own signal and identifies the traffic light B as an own signal.

Thus, the detailed description of the provisional association process (step A2) ends. Next, the integration process (step A3) will now be described in detail.

The integration process (step A3) is a process performed to generate the most part of the traffic light association data table T1, and the server 3 integrates the plurality of pieces of classification result data acquired in the provisional association process described above. In more detail, at the stage where the provisional association process described above is completed, it may not be clear which traffic lights are the same, which lanes are the same, and which lanes are the same lane of travel, that is, the same lane in which the vehicle has traveled. Therefore, for example, in a case where a plurality of pieces of classification result data have been acquired in the provisional association process, the server 3 clearly identifies the same traffic light, the same lane, and the same lane of travel by integrating the plurality of pieces of classification result data.

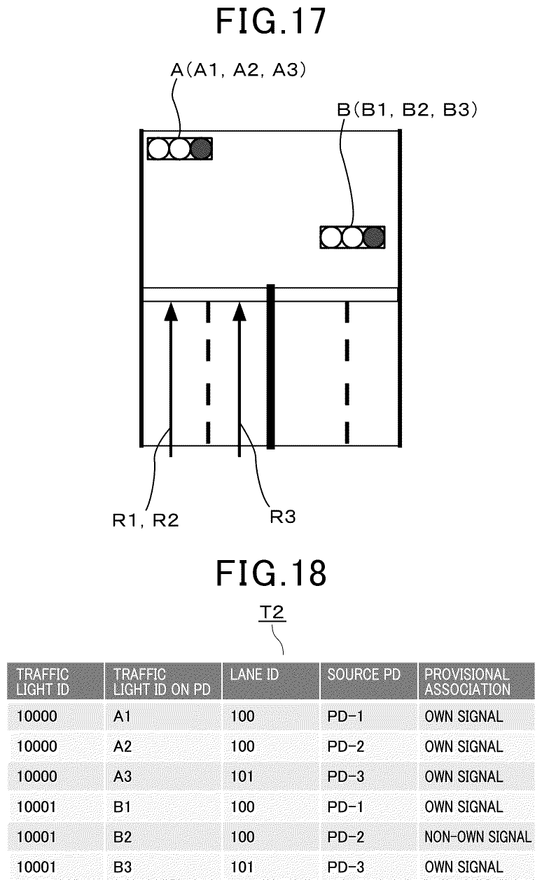

In more detail, as illustrated in FIG. 17, the server 3 integrates a plurality of pieces of data, in this case, PD-1, PD-2, and PD-3, as illustrated in FIG. 5, to identify the traffic lights A1, A2, and A3 as the same traffic light A, and assign, for example, “1000” as traffic light information.

The server 3 also identifies the traffic lights B1, B2, and B3 as the same traffic light B and assigns, for example, “10001” as traffic light information.

As illustrated in FIG. 17, the server 3 identifies the travel trajectories R1 and R2 as the same travel trajectory by integrating a plurality of pieces of data, in this case, PD-1, PD-2, and PD-3, as illustrated in FIG. 5, and assigns, for example, “100” as lane information indicating the lanes along that travel trajectory. The server 3 also identifies the travel trajectory R3 as the same travel trajectory and assigns, for example, “101” as lane information indicating the lanes along that travel trajectory.

As illustrated in FIG. 18, the server 3 generates, for the plurality of recognized traffic lights, an integration table T2 that includes various items of information such as the traffic light information, the lane information, the stop information for example illustrated in the provisional association process described above, and source PD information indicating referenced probe data. In this case, the server 3 stores, as lane information, but is not limited to, the lane information indicating the lane that the vehicle has passed through or the lane immediately before the stop line where the vehicle has made a stop. The integration table T2 may also include various items of information such as the stop information, the travel direction information, the traffic congestion information, the lighting information, and so on.

In the definitive association process (step A4), the server 3 generates the traffic light association data table T1 illustrated in FIG. 2 based on the integration table T2 generated in the integration process described above. The server 3 may set the confidence information included in the traffic light association data table T1 based on the information generated in the provisional association process. The server 3 may set the degree of confidence for each combination of lane information and traffic light information. The server 3 may set the degree of confidence by statistically processing the information generated in the provisional association process.

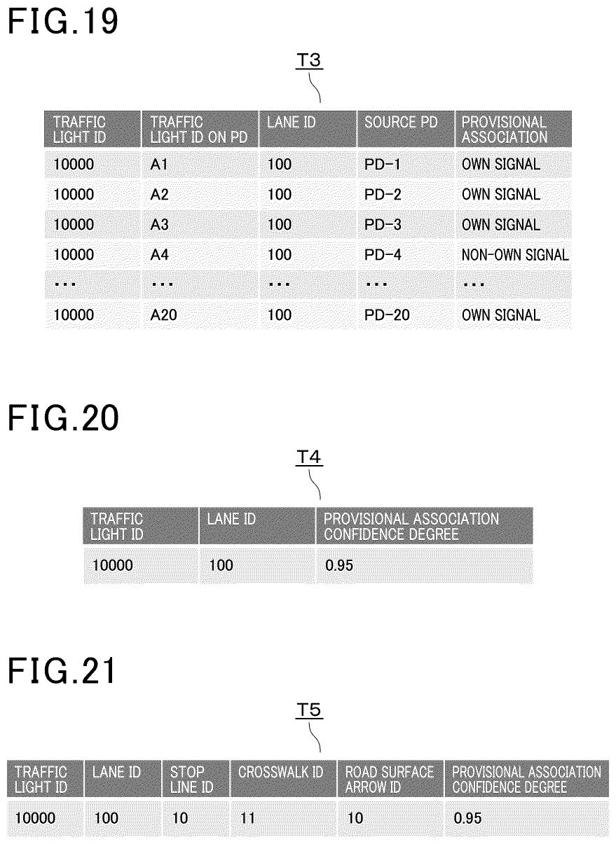

FIG. 19 illustrates an example of a method for setting the degree of confidence by the server 3, and illustrates an example of a traffic light extraction table T3 generated by extracting data from the integration table T2 described above that has been set to “10000” as traffic light information. In this case, a total of twenty pieces of data are extracted, of which nineteen pieces of data are provisionally associated as own signal, and one piece of data is provisionally associated as non-own signal. Thus, the server 3 assigns a degree of confidence of 0.95 to the traffic light whose signal information is set to “1000” in this case.

Performing such statistical processing, the server 3 generates a confidence table T4, as illustrated in FIG. 20. The server 3 performs the statistical processing described above for all combinations of lane information and traffic light information to set the degrees of confidence. The method for setting the degrees of confidence is not limited to the method described above, i.e., the method for setting the degrees of confidence based on the proportion of own signals. For example, the server 3 may quantify the probability of being determined as an own signal and the probability of being determined as a non-own signal, and set the degrees of confidence based on these values.

As illustrated in FIG. 21, the server 3 generates a reinforced confidence information table T5, which is a reinforced version of the confidence information table T4 described above, with various items of information added, such as the stop line information, crosswalk information, and road surface painting information.

In the passability information assignment process (step A5), the server 3 further assigns passability information. The passability information indicates whether the vehicle is allowed to pass through the intersection. The passability information may be expressed as a degree or rate, like the degree of confidence, or may be binary or multi-valued, for example, “1” if the vehicle is allowed to pass through the intersection and “0” if the vehicle is not allowed to pass through the intersection. The passability information may be expressed in a form of concrete characters, or in the form of abstract characters. The passability information may be expressed in a form in which, for example, a degree of confidence is assigned individually to each piece of the lighting information.

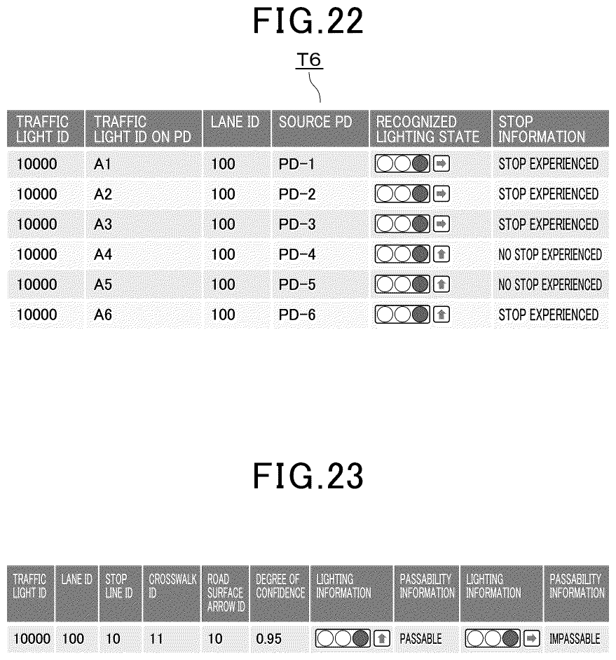

Next, an example of the method for generating passability information by the server 3 will now be described. That is, the server 3 generates passability information based on various items of information generated in the provisional association process, the integration process, and the definitive association process as described above. FIG. 22 illustrates an example of extraction data table T6 generated by extracting data in which “1000” is set as traffic light information and “100” is set as lane information from various pieces of information generated in the provisional association process, the integration process, the definitive association process and the like described above.

In this case, the vehicle has experienced a stop in all the sets of data, in which the red lighting state as recognized lighting information and the arrow lighting state that allows a right turn are stored. This pattern is hereinafter referred to as pattern 1 for convenience. On the other hand, the vehicle has experienced no stop in two of the three sets of data, in which the red lighting state as recognized lighting information and the arrow lighting state that allows going straight are stored. This pattern is hereinafter referred to as pattern 2 for convenience.

According to pattern 1, the vehicle has experienced a stop in all data sets. Therefore, as illustrated in FIG. 23, the server 3 sets “impassable” as passability information for pattern 1 data. On the other hand, according to pattern 2, the vehicle has experienced no stop in two of the three data sets. Therefore, as illustrated in FIG. 23, the server 3 sets “PASSABLE” as passability information for pattern 2 data by, for example, a majority decision. Then, server 3 assigns passability information to the plurality of traffic lights recognized by the vehicle, and finally generates the traffic light association data table T1 as illustrated in FIG. 2.

In the database update process (step A6), the server 3 updates the traffic light association data table T1 stored in the map data storage unit 12 with the newly generated traffic light association data table T1. When the traffic light association data table T1 is not stored in the map data storage unit 12, the server 3 stores, or registers, the traffic light association data table T1 generated in the current cycle in the map data storage unit 12.

When updating the traffic light association data table T1 stored in the map data storage unit 12, the server 3 may update the entire traffic light association data table T1, or may update only a part of the traffic light association data table T1, for example, only the difference from the previous data, or only certain items. When updating the traffic light association data table T1, the server 3 may adjust the degrees of confidence to be updated this time with reference to the degrees of confidence in the previous traffic light association data table T1.

The server 3 distributes the traffic light association data table T1 stored in the map data storage unit 12 to each of a plurality of on-board devices 2. The on-board device 2 that has received the latest traffic light association data table T1 from the server 3 stores that traffic light association data table T1 in the map data storage unit 8 and controls autonomous driving of the vehicle based on that traffic light association data table T1.

According to the present embodiment of the present disclosure, the server 3 is capable of generating and storing the traffic light association data table T1 in which the degrees of confidence of traffic lights as described above are set. The traffic light association data table T1 includes, at least, the lane information for identifying a lane in which a vehicle is traveling, the traffic light information for identifying a plurality of traffic lights at an intersection to which the lane is connected, and the confidence information indicating the degree of confidence set for each of the plurality of traffic lights. The traffic light association data table T1 has a data structure that allows the traffic light to be trusted to be identified by comparing the degrees of confidence set for the plurality of traffic lights depending on the lane in which the vehicle is traveling. Therefore, based on such a traffic light association data table T1, even in cases where a plurality of traffic lights are installed at an intersection to which a lane in which a vehicle is traveling is connected, the traffic light to be trusted among the plurality of traffic lights can be identified, thus implementing safer autonomous driving of the vehicle as compared to the conventional methods.

According to the server 3, the data generation unit 9e includes in the traffic light association data table T1 the lighting information indicating a lighting state of each traffic light and the passability information indicating whether the vehicle is allowed to pass through the intersection. Based on such a traffic light association data table T1, it is possible to control autonomous driving of the vehicle by checking lighting states of the traffic lights and whether the vehicle is allowed to pass through the intersection in addition to the degrees of confidence of the traffic lights, thus implementing even safer autonomous driving of the vehicle.

According to the server 3, the data generation unit 9e is configured to perform the provisional association process to classify each of the plurality of traffic lights recognized by the vehicle into an own signal which corresponds to the lane in which the vehicle is traveling or a non-own signal which does not correspond to the lane in which the vehicle is traveling, and the definitive association process to set the degrees of confidence of the traffic lights by statistical processing based on the proportion of the traffic lights recognized by the vehicle that are each classified as the own signal. That is, the data generation unit 9e is configured to set the degrees of confidence of the traffic lights through at least two-step processing, that is, the provisional association process and the definitive association process. This example configuration allows the degrees of confidence of the traffic lights to be set with even higher accuracy.

According to the server 3, the data generation unit 9e is configured to perform the integration process of integrating a plurality of pieces of classification result data acquired through the provisional association process prior to the definitive association process. In that integration process, the data generation unit 9e integrates traffic light information pertaining to the same traffic light and integrates lane information pertaining to the same lane. That is, the data generation unit 9e is configured to integrate not only the traffic light information, but also the lane information that is information other than the traffic light information. According to this example configuration, further integrating information other than the traffic light information can improve the accuracy of information integration as compared to simply integrating only the traffic light information, thereby enabling more accurate identification of the traffic lights and assignment of degrees of confidence to those traffic lights.

According to the server 3, the data generation unit 9e is capable of generating the traffic light information for the traffic lights actually recognized by analyzing images captured by an on-board camera mounted to the vehicle, rather than traffic light information stored in existing map data. According to this example configuration, for example, the traffic light information can be generated for new traffic lights that are not stored in the existing map data, as long as the new traffic lights are actually recognized by the vehicle, and data can be generated according to the real road conditions that are not reflected in the existing map data.

In the server 3, the data generation unit 9e may be configured such that when the generated degree of confidence is lower than a predefined criterion value, the degree of confidence is made unavailable for reference. This can prevent traffic lights having too low degrees of confidence from being trusted when controlling autonomous driving of the vehicle. The predefined criterion value may be expressed as a predefined value in a suitable form of expression, such as 0.5 or 50 percent. The setting that makes the degree of confidence lower than the predefined criterion value unavailable for reference may be made by the on-board device 2 instead of the server 3.

The present disclosure is not limited to any of the embodiments, and may be modified or extended as appropriate without departing from the scope of the disclosure. For example, each of the plurality of on-board devices 2 may be equipped with various functions of the server 3. That is, the map generation system 1 of the present disclosure may be configured as a stand-alone on-board device 2. The on-board camera is not limited to a front camera that captures images forward of the vehicle, but may also be used in combination with side cameras that capture images sideward of the vehicle and a rear camera that captures images rearward of the vehicle. The present disclosure may also be applied to data for controlling autonomous driving of moving objects other than automobiles, such as bicycles, as well as autonomous driving of automobiles.

Although the present disclosure has been described in accordance with the above-described embodiments, it is not limited to such embodiments, but also encompasses various variations and variations within equal scope. In addition, various combinations and forms, as well as other combinations and forms, including only one element, more or less, thereof, are also within the scope and idea of the present disclosure.

The control units and their methods described in relation to the present disclosure may be implemented by a dedicated computer that is provided by forming a processor and a memory programmed to execute one or more functions embodied by a computer program. Otherwise, the control units and their methods described in relation to the present disclosure may be implemented by a dedicated computer that is provided by forming a processor from one or more dedicated hardware logic circuits. Alternatively, the control units and their methods described in relation to the present disclosure may be implemented by one or more dedicated computers that are formed by a combination of a processor and a memory programmed to execute one or more functions and one or more hardware logic circuits. The computer program may be stored as instructions to be executed by a computer in a computer-readable non-transitory tangible recording medium.

What is claimed is:

1. A data generation device comprising:
a data generation unit configured to generate data, the data generation unit being further configured to generate, as the data, traffic light identification data including lane information for identifying a lane in which a vehicle is traveling, traffic light information for identifying a plurality of traffic lights installed at an intersection to which the lane is connected, and confidence information indicating a degree of confidence set for each of the plurality of traffic lights, the traffic light identification data having a data structure that allows the traffic light that should be trusted to be identified based on the degrees of confidence set for the plurality of traffic lights depending on the lane in which the vehicle is traveling.

2. The data generation device according to claim 1, wherein
the data generation unit includes in the traffic light identification data lighting information indicating a lighting state of each of the plurality of traffic lights and passability information indicating whether the vehicle is allowed to pass through the intersection.

3. The data generation device according to claim 1, wherein
the data generation unit is configured to perform a provisional process of classifying each of the plurality of traffic lights recognized by the vehicle into an own signal which corresponds to the lane in which the vehicle is traveling or a non-own signal which does not correspond to the lane in which the vehicle is traveling, and a definitive process of setting the degrees of confidence by statistically processing classification result data acquired the provisional process.

4. The data generation device according to claim 3, wherein
the data generation unit is configured to perform an integration process of integrating a plurality of pieces of classification result data acquired through the provisional process prior to the definitive process, and in that integration process, integrate the traffic light information pertaining to a same traffic light and integrate the lane information pertaining to a same lane.

5. The data generation device according to claim 1, wherein
the data generation unit is configured to make the degree of confidence lower than a predefined criterion value unavailable for reference.

6. The data generation device according to claim 1, wherein
the data generation unit is capable of generating the traffic light information for the traffic lights recognized by the vehicle.

7. A data storage device comprising:
a data storage unit configured to store data, the data storage unit being further configured to store, as the data, traffic light identification data including lane information for identifying a lane in which a vehicle is traveling, traffic light information for identifying a plurality of traffic lights installed at an intersection to which the lane is connected, and confidence information indicating a degree of confidence set for each of the plurality of traffic lights, the traffic light identification data having a data structure that allows the traffic light that should be trusted to be identified based on the degrees of confidence set for the plurality of traffic lights depending on the lane in which the vehicle is traveling.
